(19) United States
(12) Patent Application Publication
(10) Pub. No.: US 2025/0309347 A1
(43) Pub. Date: Oct. 2, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: SUNDAE KIM, Yongin-si (KR); Yeji YANG, Yongin-si (KR); SANGHOON KIM, Yongin-si (KR); HYUNBONG CHOI, Yongin-si (KR); Sangwoo PARK, Yongin-si (KR); Hongryeol PARK, Yongin-si (KR); Dahyun KIM, Yongin-si (KR)

(21) Appl. No.: 18/924,860

(22) Filed: Oct. 23, 2024

(30) Foreign Application Priority Data
Mar. 28, 2024 (KR) 10-2024-0042728

(51) Int. Cl. H01M 10/0567; H01M 4/587; H01M 10/052; H01M 10/0569

(52) U.S. Cl. CPC H01M 10/0567; H01M 4/587; H01M 10/052; H01M 10/0569; H01M 2300/004

(57) ABSTRACT

An electrolyte and a rechargeable lithium batteries including the same are provided. The electrolyte comprises a non-aqueous organic solvent, a lithium salt, and an additive represented by Chemical Formula 1.

### CROSS-REFERENCE TO RELATED APPLICATION

The application claims priority to and the benefit of Korean Patent Application No. 10-2024-0042728, filed on Mar. 28, 2024, in the Korean Intellectual Property Office, the entire disclosure of which is hereby incorporated by reference.

### BACKGROUND

### 1. Field

According to one or more embodiments of the present disclosure relates to an electrolyte for a rechargeable lithium battery and a rechargeable lithium battery including the electrolyte.

### 2. Description of the Related Art

Recently, with the rapid spread of battery-using electronic and/or electric devices, such as mobile phones, laptop computers, electric vehicles, and/or the like, there is a rapidly increasing desire or demand for batteries (used in these electronic and/or electric devices), e.g., rechargeable batteries, with relatively high energy density and relatively high capacity. Therefore, intensive research has been conducted to improve performance of such rechargeable batteries, e.g., rechargeable lithium batteries.

A rechargeable lithium battery includes a positive electrode, a negative electrode, and an electrolyte, in which the positive and negative electrodes (e.g., each) include an active material in which intercalation and deintercalation (e.g. of lithium ions) are possible. For example, the rechargeable lithium battery generates electrical energy caused by oxidation and reduction reactions if (e.g., when) lithium ions are intercalated and deintercalated.

A lithium salt dissolved in a non-aqueous organic solvent is used as the electrolyte of the rechargeable lithium battery. Characteristics of the rechargeable lithium battery are exhibited by complex reactions between the positive electrode and the electrolyte and between the negative electrode and the electrolyte. Accordingly, the use of an appropriate or suitable electrolyte is one of the primary and/or important variables for improvement of the performance of the rechargeable lithium battery.

### SUMMARY

One or more aspects are directed toward an electrolyte for a rechargeable lithium battery with improved stability and lifetime characteristics at high temperatures.

One or more aspects are directed toward a rechargeable lithium battery including the electrolyte.

Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; and an additive represented (e.g., expressed) by Chemical Formula 1.

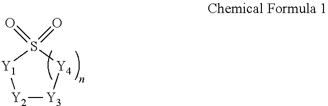

In Chemical Formula 1, one of (e.g., selected from among) Y₁ to Y₄ may be or have a structure of Chemical Formula 2.

Each remaining selected from among Y₁ to Y₄ (e.g., of Y₁ to Y₄ other than the one) may be or have a structure of Chemical Formula 3.

n may be an integer of 1 to 5.

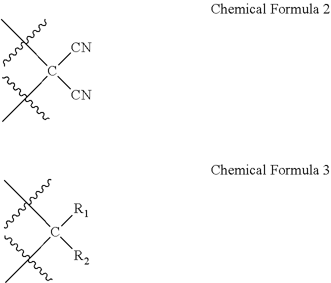

In Chemical Formula 3, R₁ and R₂ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

According to one or more embodiments of the present disclosure, a rechargeable lithium battery may include: a positive electrode that includes a positive electrode active material; a negative electrode that includes a negative electrode active material; and the electrolyte for the rechargeable lithium battery.

### BRIEF DESCRIPTION OF THE DRAWINGS

FIG. 1 illustrates a simplified conceptual diagram showing a rechargeable lithium battery according to one or more embodiments of the present disclosure.

FIGS. 2-5 illustrate simplified diagrams each showing a rechargeable lithium battery according to one or more embodiments of the present disclosure.

FIGS. 6 and 7 illustrate graphs showing results of cyclic voltammetry (CV) according to Example Embodiments and Comparative Examples of the present disclosure.

### DETAILED DESCRIPTION

In order to sufficiently understand the configuration and aspects of the present disclosure, one or more embodiments of the present disclosure will be described with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components are exaggerated for effectively explaining the technical contents. Like reference numerals refer to like elements throughout, and duplicative descriptions thereof may not be provided the specification.

Unless otherwise specially noted in this description, an expression in the singular form may include the expression(s) in the of plural form(s). For example, unless otherwise specially noted, the phrase “A or B” may indicate “A but not B”, “B but not A”, and “A and B”.

The terms “comprises/includes,” “comprising/including,” “comprise/include,” “having,” “has,” and/or “have”, as used in this description, are intended to designate the presence of an embodied aspect, number, step (e.g., act or task), element, and/or a (e.g., any suitable) combination thereof. However, the use of these terms does not preclude or exclude the possibility or the presence or addition of one or more other components, features, numbers, steps (e.g., acts or tasks), elements, and/or a (e.g., any suitable) combination thereof.

As used herein, the term “combination thereof” may refer to a mixture, a stack, a composite, a copolymer, an alloy, a blend, or a reaction product.

In one or more embodiments, the term “layer” herein includes not only a shape formed or provided on the whole surface if (e.g., when) viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if (e.g., when) preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if (e.g., when) the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

The terminology utilized herein is utilized for the purpose of describing particular embodiments only, and is not intended to limit the present disclosure. Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments are described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the present claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item.

In this context, “consisting essentially of” indicates that any additional components will not materially affect the chemical, physical, optical or electrical properties of the semiconductor film.

In the context of the present application and unless otherwise defined, the terms “use,” “using,” and “used” may be considered synonymous with the terms “utilize,” or “utilization,” “utilizing,” and “utilized,” respectively.

In this description, a direct linkage may refer to a single bond.

In this description, “ [symbol] ” may indicate a connection position.

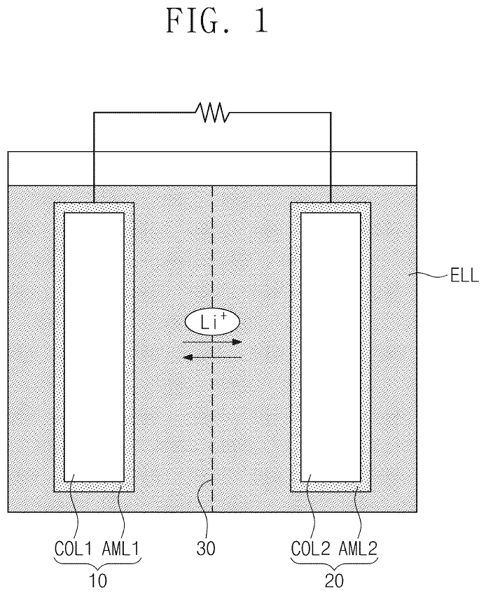

### Description of FIG. 1

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in (and/or with) the electrolyte ELL.

The electrolyte ELL may be a medium by which lithium ions are transferred between the positive electrode 10 and the negative electrode 20. In the electrolyte ELL, the lithium ions may move through the separator 30 toward one selected from among the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material (e.g., electron conductor).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be used to provide an electrode with conductivity, and any suitable conductive material without causing chemical change of a battery may be used as the conductive material to constitute the battery. The conductive material may include, for example, a carbon-based material such as natural graphite, artificial graphite, carbon black, acetylene black, Ketjenblack, carbon fiber, carbon nano-fiber, and carbon nano-tube; a metal powder or metal fiber containing one or more of copper, nickel, aluminum, and silver; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from among cobalt, manganese, nickel, and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a (e.g., any suitable) combination thereof.

For example, the positive electrode active material may include a compound represented (e.g., expressed) by one selected from among chemical formulae. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae herein, A may be Ni, Co, Mn, and/or a (e.g., any suitable) combination thereof, X may be Al, Ni, Co, Mn, Cr, Fe, Mg, Sr, V, a rare-earth element, and/or a (e.g., any suitable) combination thereof, D may be O, F, S, P, and/or a (e.g., any suitable) combination thereof, G may be Al, Cr, Mn, Fe, Mg, La, Ce, Sr, V, and/or a (e.g., any suitable) combination thereof, and L¹ may be Mn, Al, and/or a (e.g., any suitable) combination thereof.

For example, the positive electrode active material may be a high nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material (e.g., electron conductor).

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrine, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a (e.g., any suitable) combination thereof.

If (e.g., when) an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material may be used to provide an electrode with conductivity, and any suitable conductive material without causing chemical change of a battery may be used as the conductive material to constitute the battery. For example, the conductive material may include a carbon-based material such as natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, silicon-carbon composite, SiOₓ (where 0<x≤2), Si-Q alloy (where Q is alkali metal, alkaline earth metal, Group 13 element, Group 14 element (except for Si), Group 15 element, Group 16 element, transition metal, a rare-earth element, and/or a (e.g., any suitable) combination thereof), and/or a (e.g., any suitable) combination thereof. The Sn-based negative electrode active material may include Sn, SnOx (0<x≤2), e.g., SnO₂, a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled (agglomerated), and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on type or kind of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, and polytetrafluoroethylene (e.g., Teflon), or may be a copolymer or mixture including two or more of the materials mentioned herein.

The organic material may include a polyvinylidenefluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be present mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The aprotic solvent may include nitriles such as R-CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In some embodiments, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

1 The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers between 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB).

### Rechargeable Lithium Battery

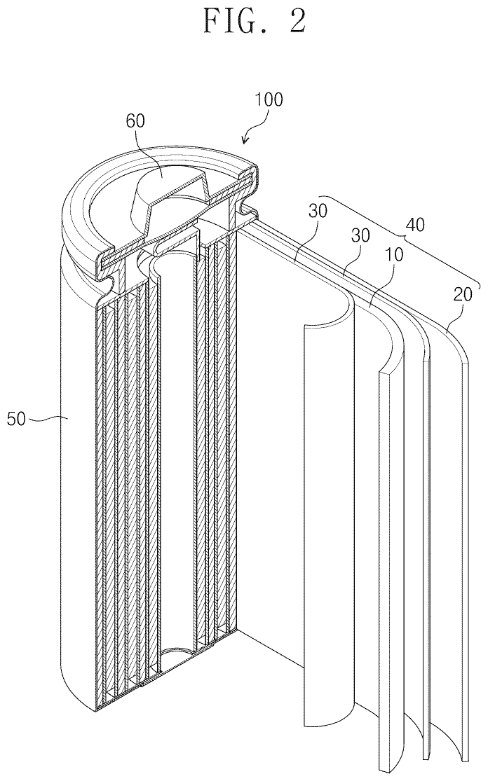

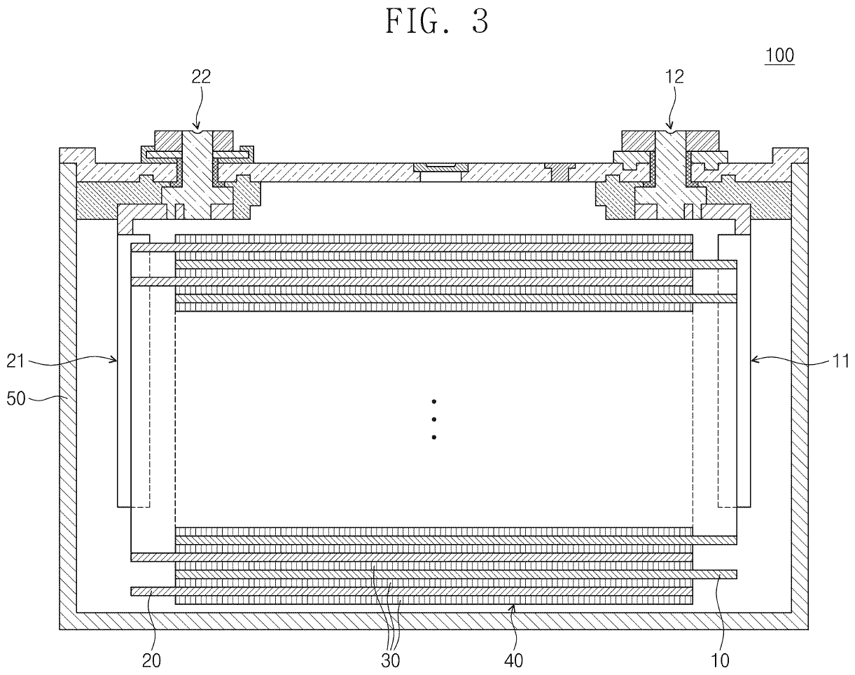

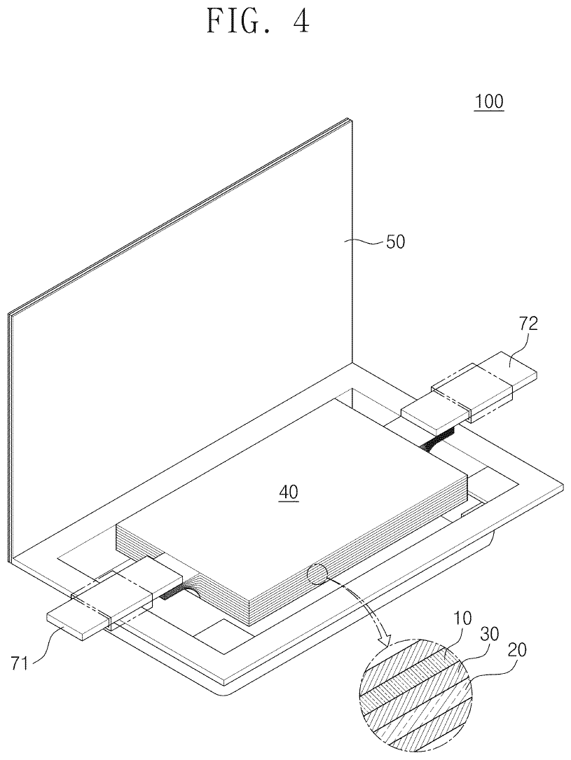

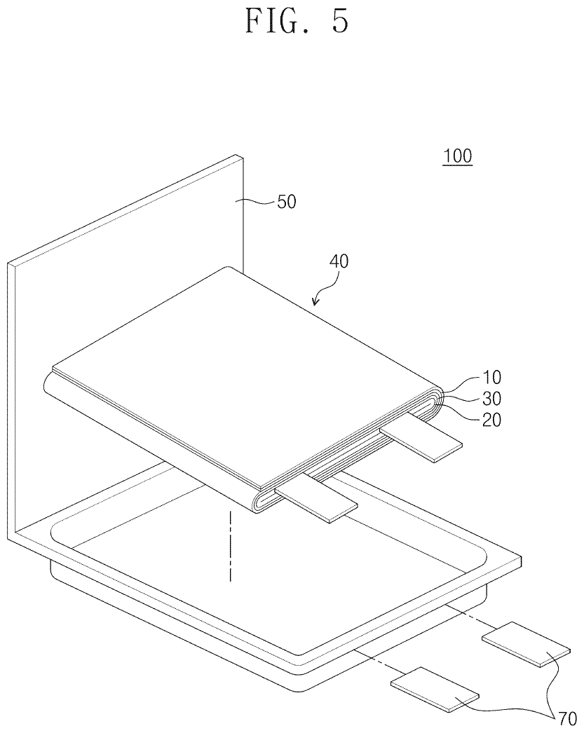

Based on shape of a rechargeable lithium battery, the rechargeable lithium battery may be classified into cylindrical, prismatic, pouch, and coin types (kinds). In FIGS. 2 to 5 illustrating simplified diagrams each showing a rechargeable lithium battery according to one or more embodiments, FIG. 2 shows a cylindrical battery, FIG. 3 shows a prismatic battery, and FIGS. 4 and 5 show pouch-type or kind batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In some embodiments, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include electrode tabs 70, or a positive electrode tab 71 and a negative electrode tab 72, which electrode tabs 70-72 serve as an electrical path for externally inducing a current generated in the electrode assembly 40.

### Electrolyte

The following will describe in more detail an electrolyte for a rechargeable lithium battery according to one or more embodiments of the present disclosure.

An electrolyte for a rechargeable lithium battery according to one or more embodiments may include a non-aqueous organic solvent, a lithium salt, and an additive.

The additive according to one or more embodiments of the present disclosure may be a material represented (e.g., expressed) by Chemical Formula 1.

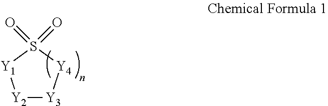

In Chemical Formula 1, one of (e.g., selected from among) Y₁ to Y₄ may be a structure of Chemical Formula 2.

Each remaining selected from among Y₁ to Y₄ (e.g., of Y₁ to Y₄ other than the one) may be a structure of Chemical Formula 3,

n may be an integer of 1 to 5.

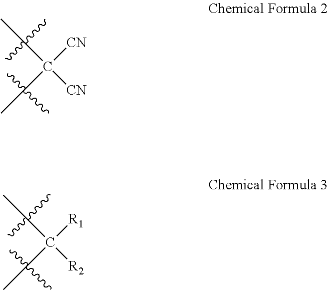

In Chemical Formula 3, R₁ and R₂ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group.

Chemical Formula 1 may include two cyano groups (—CN) connected to one (e.g., the same) carbon atom. For example, the additive according to one or more embodiments of the present disclosure may include a structure such as Chemical Formula 2 in which a pair of (e.g., two) cyano groups is (are) connected to one (e.g., the same) carbon atom.

In one or more embodiments of the present disclosure, if (e.g., when) n of Chemical Formula 1 is at least 2 (e.g., 2 or more), a compound of Chemical Formula 1 may include at least one (e.g., a plurality of) Y₄'s. The at least one (e.g., plurality of) Y₄'s may be the same as or different from each other.

The structure of Chemical Formula 2 may not be adjacent to a sulfonyl group (—SO₂). For example, the structure of Chemical Formula 2 may be represented by or correspond to Y₂ or Y₃.

According to one or more embodiments, Chemical Formula 1 may be represented by one selected from among Chemical Formulae 1-1, 1-2, and 1-3.

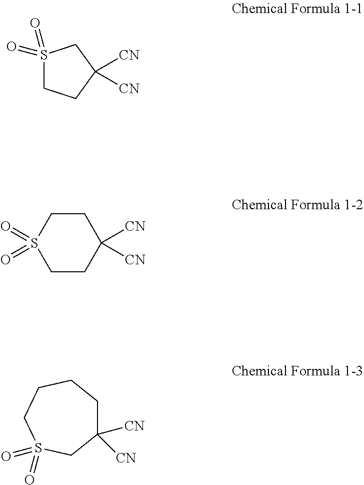 [SMILES: N#CC1(C#N)CCS(=O)(=O)C1 ; N#CC1(C#N)CCS(=O)(=O)CC1 ; N#CC1(C#N)CCCCS(=O)(=O)C1]

The additive according to one or more embodiments of the present disclosure may be a cyclic compound including two cyano groups (—CN) and a sulfonyl group (—SO₂).

Because the additive according to one or more embodiments of the present disclosure includes the sulfonyl group (—SO₂), a stable film (e.g., a solid electrolyte interface (SEI) film) may be formed on a surface of the positive electrode to suppress or reduce decomposition of the positive electrode active material. Thus, it may be possible to suppress or reduce the gas generation due to the decomposition of the positive electrode active material.

Because the additive according to one or more embodiments of the present disclosure has a structure in which the cyano group (—CN) is directly connected to one carbon atom, it may be possible to achieve strong electron-attracting (e.g., electrophilic) characteristics. For example, because two cyano groups (—CN) are directly connected to one (e.g., the same) carbon atom, a stable and strong bonding force may be accomplished. Such structural properties may suppress or reduce dissolution of transition metal to effectively inhibit or reduce degradation of the positive electrode.

Because the additive according to one or more embodiments of the present disclosure has a structure including both (e.g., simultaneously) the sulfonyl group (—SO₂) and the cyano group(s) (—CN), the additive may effectively contribute to high-voltage stability and cycle-life characteristics of lithium batteries.

The additive may be included in an amount of about 0.01 wt % to about 10 wt % relative to the total amount of the electrolyte. For example, the additive may be included in an amount of about 0.5 wt % to about 3 wt % relative to the total weight of the electrolyte. If (e.g., when) an amount of the additive is less than the ranges described herein, there may occur a problem where a film (e.g., SEI film) cannot be sufficiently formed on lithium-based positive and negative electrodes. If (e.g., when) an amount of the additive is greater than the ranges described herein, there may occur a problem where battery capacity and lifetime are reduced due to an increase in resistance of the positive and negative electrodes.

The electrolyte may be manufactured by a mixing process in which the lithium salt is dissolved in the non-aqueous organic solvent and the additive is added to mixture. The electrolyte mixing process is widely suitable in electrolyte fabrication field, and a person skilled in the art will be able to appropriately or suitably select and use.

The non-aqueous organic solvent may include at least one selected from among ethylmethyl carbonate (EMC), ethylene carbonate (EC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous organic solvent may be a mixed solvent of ethylmethyl carbonate (EMC), ethylene carbonate (EC), and dimethyl carbonate (DMC).

The ethylmethyl carbonate (EMC), the ethylene carbonate (EC), and the dimethyl carbonate (DMC) may have a volume ratio of 1:a:b, The a may be about 1 to about 3, and the b may be about 5 to about 8.

For example, the ethylmethyl carbonate (EMC) may be included in an amount of about 5 vol % to about 20 vol % relative to the total volume of the non-aqueous organic solvent. The ethylene carbonate (EC) may be included in an amount of about 10 vol % to about 30 vol % relative to the total volume of the non-aqueous organic solvent. The dimethyl carbonate (DMC) may be included in an amount of about 60 vol % to about 80 vol % relative to the total volume of the non-aqueous organic solvent.

The lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃. According to one or more embodiments, the lithium salt may include LiPF₆.

The lithium salt may have a concentration of about 0.1 M to about 2.0 M. For example, the lithium salt may have a concentration of equal to or greater than about 0.5 M or about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain its conductivity and viscosity.

In one or more embodiments of the present disclosure, a rechargeable lithium battery may include a positive electrode that includes a positive electrode active material, a negative electrode that includes a negative electrode active material, and an electrolyte, and the electrolyte may include a non-aqueous organic solvent, a lithium salt, an additive represented (e.g., expressed) by Chemical Formula 1.

The positive electrode active material of the rechargeable lithium battery may include one or more selected from among cobalt-free nickel-manganese-based oxide, lithium-nickel-based oxide, lithium-cobalt-based oxide, lithium-manganese-based oxide, lithium-iron-phosphate-based compounds, and any combination thereof. For example, the positive electrode active material may include cobalt-free nickel-manganese-based oxide.

In a rechargeable lithium battery using an electrolyte according to the present disclosure, the negative electrode active material may include a carbon-based negative electrode active material, a silicon-based negative electrode active material, or any combination thereof.

The silicon-based negative electrode active material may include a core including silicon-based particles and a coating layer including amorphous carbon. The silicon-based particles may include one or more silicon particles (e.g., one silicon particles or multiple silicon particles), a silicon-carbon composite, SiOₓ (where 0<x≤2), and a silicon alloy.

The rechargeable lithium battery may operate even at high voltages of equal to or greater than about 4.5 V. To put it another way, the rechargeable lithium batteries of present disclosure may operate (i.e., be operable) even at high voltages of at least about 4.5 V.

The rechargeable lithium battery may be applied to automotive vehicles, mobile phones, and/or any other electrical devices, but the present disclosure is not limited thereto.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

The following will describe Example Embodiments and Comparative Examples of the present disclosure. The following Example Embodiments, however, are merely one or more possible examples, and the present disclosure is not limited to Example Embodiments discussed.

### Example Embodiments and Comparative Examples

### Synthesis Example 1

35 g (0.254 mol) of potassium carbonate and 5.6 g (0.084 mol) of malononitrile were added to 100 mL of anhydrous tetrahydrofuran, and the mixture was stirred with a magnetic agitator for 30 minutes at room temperature. Afterwards, 10.0 g (0.084 mol) of divinyl sulfone was dissolved in 20 mL of anhydrous tetrahydrofuran and slowly added dropwise to a reaction product, and the solution was stirred for 5 hours. If (e.g., when) the reaction was completed, precipitates were removed through filtration, and the solution was distilled under reduced pressure. A produced white solid was washed with hexane and dried to eventually synthesize an additive (e.g., compound) represented (e.g., expressed) by Chemical Formula 1-2.

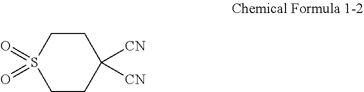 [SMILES: N#CC1(C#N)CCS(=O)(=O)CC1]

### Example Embodiment 1

### (1) Preparation of Electrolyte

1.5M LiPF₆ was dissolved in a non-aqueous organic solvent including ethylene carbonate (EC), ethylmethyl carbonate (EMC), and dimethyl carbonate (DMC) mixed in a volume ratio of about 20:10:70, and 0.5 wt % of an additive was added to prepare an electrolyte.

The compound represented (e.g., expressed) by Chemical Formula 1-2 manufactured in Synthesis Example 1 was used as the additive.

### (2) Fabrication of Rechargeable Lithium Battery

97 wt % LiNiMnO (NMX) as a positive electrode active material, 0.5 wt % artificial graphite powder as a conductive material, 0.8 wt % of carbon black (Ketjen black), 0.2 wt % acrylonitrile rubber, 1.5 wt % polyvinylidene fluoride (PVdF) were mixed and added to N-methyl-2-pyrrolidone, and then the mixture was stirred for 30 minutes by using a mechanical agitator to prepare a positive electrode active material slurry. A doctor blade was used to coat the slurry with a thickness of about 60 micrometer (μm) on an aluminum current collector of about 20 μm, dried in a hot-air drier for 0.5 hours at 100° C., dried again for 4 hours at 120° C. under a vacuum condition, and then roll-pressed to manufacture a positive electrode.

98 wt % of a negative electrode active material containing artificial graphite and a silicon composite mixed in a volume ratio of 93:7, 1 wt % of styrene-butadiene rubber (SBR), and 1 wt % of carboxymethyl cellulose (CMC) were mixed, based on a total weight of 100 wt % of the produced mixture, which was added to distilled water, and then stirred for 60 minutes by using a mechanical agitator to prepare a negative electrode active material slurry. A doctor blade was used to coat the slurry with a thickness of about 60 μm on a copper current collector of about 10 μm, dried in a hot-air drier for 0.5 hours at 100° C., dried again for 4 hours 120° C. under a vacuum condition, and then roll-pressed to manufacture a negative electrode.

The positive electrode, the negative electrode, and a polyethylene separator of 10 μm in thickness were assembled to manufacture an electrode assembly, and the electrolyte was introduced to fabricate a rechargeable lithium battery.

### Example Embodiment 2

An electrolyte and a rechargeable lithium battery were fabricated in substantially the same method as in Example Embodiment 1, except that 1.0 wt % of the additive was applied.

### Example Embodiment 3

An electrolyte and a rechargeable lithium battery were fabricated in substantially the same method as in Example Embodiment 1, except that 3.0 wt % of the additive was applied.

### Example Embodiment 4

An electrolyte and a rechargeable lithium battery were fabricated in substantially the same method as in Example Embodiment 1, except that the additive represented (e.g., expressed) by Chemical Formula 1-1 was used as the additive.

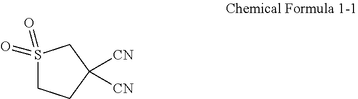 [SMILES: N#CC1(C#N)CCS(=O)(=O)C1]

### Example Embodiment 5

An electrolyte and a rechargeable lithium battery were fabricated in substantially the same method as in Example Embodiment 1, except that the additive represented (e.g., expressed) by Chemical Formula 1-3 was used as the additive.

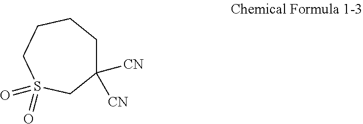 [SMILES: N#CC1(C#N)CCCCS(=O)(=O)C1]

### Comparative Example 1

An electrolyte and a rechargeable lithium battery were fabricated in substantially the same method as in Example Embodiment 1, except that the compound represented (e.g., expressed) by Chemical Formula 1-2 was used as the additive to prepare the electrolyte.

### Comparative Example 2

An electrolyte and a rechargeable lithium battery were fabricated in substantially the same method as in Example Embodiment 1, except that an additive represented (e.g., expressed) by Chemical Formula 1-4 was used as the additive.

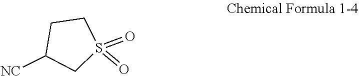

### Evaluation Example

A rechargeable lithium battery was evaluated by the following method.

### Evaluation 1: CV Characteristics

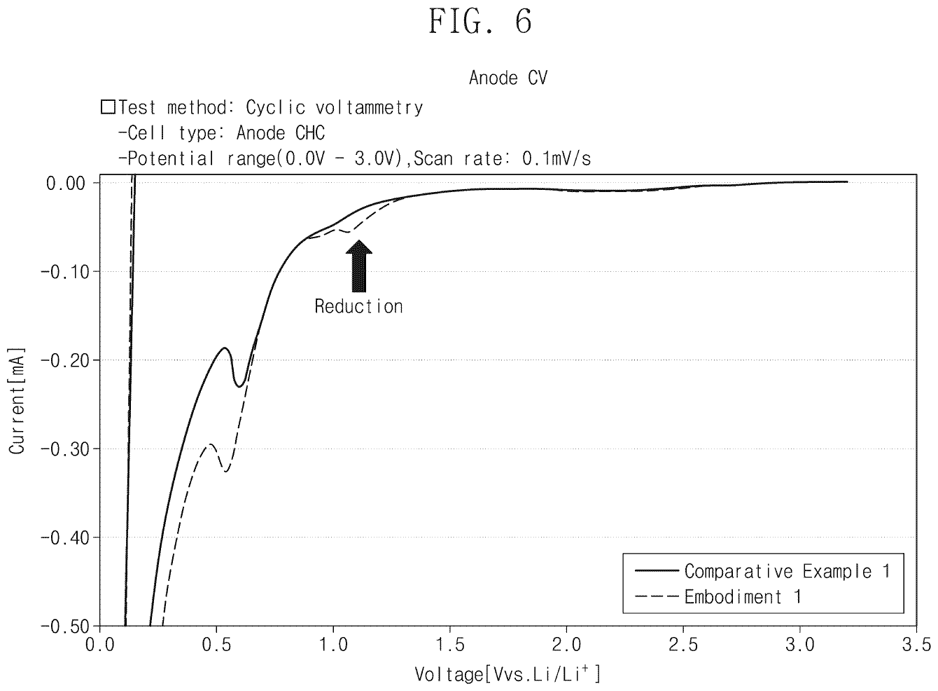

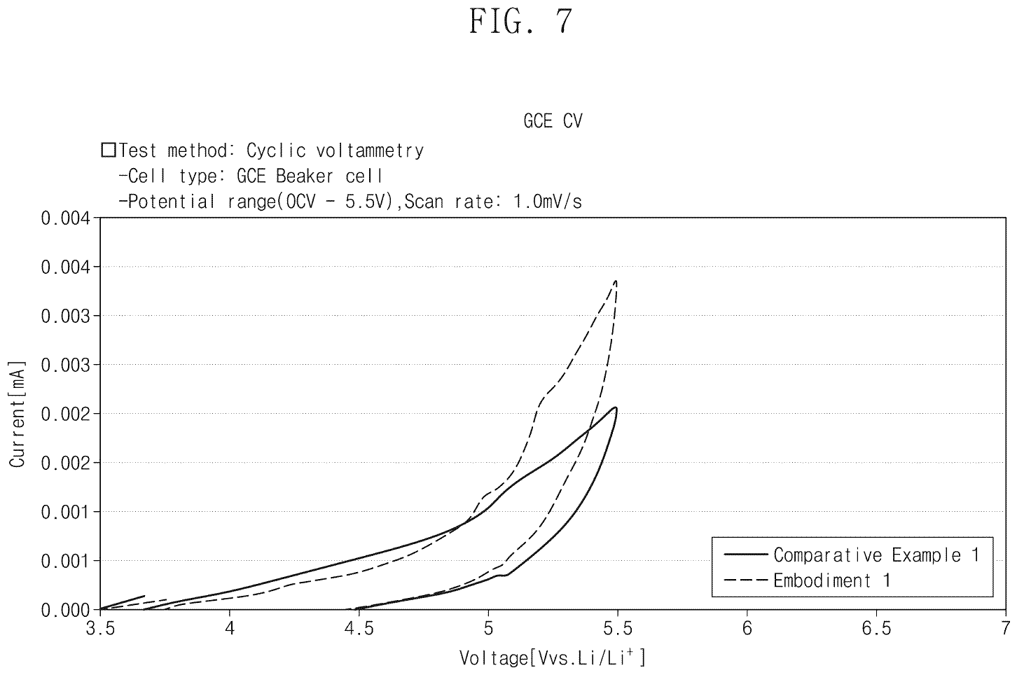

A cyclic voltammetry process (CV) was measured at room temperature (25° C.) to evaluate the electrochemical stability of the electrolytes used in Example Embodiment 1 and Comparative Example 1, and the measured results are depicted in FIGS. 6 and 7. FIG. 6 illustrates a graph showing results of the negative electrode cyclic voltammetry (CV) according to Example Embodiment 1 and Comparative Example 1. FIG. 7 illustrates a graph showing cyclic voltammetry (CV) of glassy carbon electrodes (GCE) according to Example Embodiment 1 and Comparative Example 1.

A negative cyclic voltammetry (CV) measurement was performed by using a coin half-cell in which a graphite negative electrode was used as a working electrode and Li metal was used as a counter electrode. In this measurement, a scan was performed at a rate of 0.1 millivolt per second (mV/sec) in a range from 3.0 volt (V) to 0 V.

A cyclic voltammetry (CV) of glassy carbon electrodes (GCE) was measured by using a coin half-cell in which a glassy carbon electrode (GCE) was used as a working electrode, a platinum (Pt) wire was used as a counter electrode, and a saturated calomel electrode was used as a reference electrode.

In this measurement, a scan was performed at a rate of 0.1 mV/see in a range from 5.0 V to an open circuit voltage (OCV).

### Evaluation 2: High-Temperature Storage Characteristics (DC-IR Change Rate)

1 The rechargeable lithium batteries fabricated according to the Example Embodiments 1 to 5 and Comparative c 1 were measured with respect to ΔV/ΔI (voltage change/current change). The initial direct current internal resistance (DC-IR) and direct current internal resistances (DC-IR) were measured in milliohm (mΩ) by allowing the batteries to change their internal maximum energy states into full-charge states (SOC 100%), and in this stage, the batteries were stored at a high temperature (60° C.) for 30 days to calculate DC-IR increase rates (%) according to Equation 1 and to list the calculated results in Table 1.

$$DC - IR increase rate = ( DC - IR after 30 days / initial DC - IR ) \times 100 \qquad [ Equation 1 ]$$

TABLE 1

| | Initial | DC-IR after storage for | DC-IR |
|---|---|---|---|
| | DC-IR | 30 days at 60° C. | increase rate |
| Category | mΩ | mΩ | % |
| Comparative | 9.62 | 15.35 | 159 |
| Example 1 | | | |
| Example | 9.88 | 13.89 | 140 |
| Embodiment 1 | | | |
| Example | 9.84 | 13.91 | 141 |
| Embodiment 2 | | | |
| Example | 9.88 | 14.01 | 142 |
| Embodiment 3 | | | |
| Example | 9.91 | 13.87 | 140 |
| Embodiment 4 | | | |
| Example | 9.87 | 13.74 | 139 |
| Embodiment 5 | | | |

### Evaluation 3: Gas Generation at High Temperature

The rechargeable lithium batteries according to Example Embodiments 1 to 5 and Comparative Example 1 underwent evaluation of gas generation characteristics at high temperature. The rechargeable lithium batteries according to Example Embodiments 1 to 5 and Comparative Example 1 were charged to 4.53 V at 45° C. and then left for 30 days at 60° C.

To ascertain a gas reduction aspect, an initial thickness of the cell battery and a thickness of the cell battery after 7 days were each measured, and results are listed in Table 2.

TABLE 2

Gas generation amount at high temperature
(60° C.) (mL)

| Category | 1^{st} day | 7^{th} day |
|---|---|---|
| Comparative | 0.033 | 0.080 |
| Example 1 | | |
| Example | 0.027 | 0.067 |
| Embodiment 1 | | |
| Example | 0.027 | 0.060 |
| Embodiment 2 | | |
| Example | 0.028 | 0.059 |
| Embodiment 3 | | |
| Example | 0.029 | 0.064 |
| Embodiment 4 | | |
| Example | 0.030 | 0.069 |
| Embodiment 5 | | |

### Evaluation 4: High-Temperature Charge/Discharge Cycle Characteristics

The rechargeable lithium batteries fabricated in Example Embodiments 1 to 5 and Comparative Example 1 were charged and discharged at 60° C. for 200 cycles under the conditions of 2.0C charge (CC/CV, 4.53V Cut-off) and 1.0C discharge (CC, 3.0V Cut-off), and high-temperature capacity retention rates were calculated and listed in Table 3. The high-temperature capacity retention rate was calculated according to Equation 2.

$$High - temperature capacity retention rate ( \% ) = ( discharge capacity after 200 cycles / initial discharge capacity ) \times 100 \qquad Equation 2$$

TABLE 3

| | High-temperature capacity |
|---|---|
| Category | retention rate (%) |
| Comparative | 89.1 |
| Example 1 | |
| Example | 92.3 |
| Embodiment 1 | |
| Example | 93.8 |
| Embodiment 2 | |
| Example | 93.2 |
| Embodiment 3 | |
| Example | 92.8 |
| Embodiment 4 | |
| Example | 92.7 |
| Embodiment 5 | |

### Comprehensive Evaluation

Referring to FIG. 6, it may be ascertained that, compared to Comparative Example 1, the electrolyte of Example Embodiment 1 exhibits a reductive decomposition peak at a higher voltage (e.g., about 1.1 V). Thus, it may be expected that the electrolyte according to Example Embodiment 1 causes the formation of an initial solid electrolyte interface (SEI) film on the negative electrode before the occurrence of solvent decomposition during a charge procedure in which lithium ions are intercalated into the negative electrode.

Referring to FIG. 7, it may be ascertained that an operation is possible at a higher current in the electrolyte according to Example Embodiment 1 compared to Comparative Example 1.

Referring to Table 1, it may be observed that there was an improvement in high-temperature storage (60° C.) in cases (Example Embodiments 1 to 5) each using an electrolyte with the additive according to the present disclosure, compared to a case (Comparative Example 1) using an electrolyte without any additive.

Referring to Table 2, it may be observed that the rechargeable lithium battery fabricated according to Comparative Example 1 has a large amount of gas generation at high-temperature storage (60° C.) compared to the rechargeable lithium batteries fabricated according to the Example Embodiments. Therefore, the gas generation at a high temperature (60° C.) may be effectively suppressed or reduced in the rechargeable lithium battery that uses the additive represented (e.g., expressed) by Chemical Formula 1 according to the present disclosure.

Referring to Table 3, it may be observed that battery cycle characteristics and lifetime efficiency under the environment of high-temperature storage (60° C.) are improved in a case using an electrolyte with the additive according to the present disclosure than in a case using an electrolyte without any additive.

In an electrolyte according to one or more embodiments, a cyclic compound including a cyano group (—CN) and a sulfonyl group (—SO₂) may be used as an additive, and thus lifetime characteristics and stability under the condition of high temperature may be improved if (e.g., when) rechargeable batteries are activated.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Descriptions of features or aspects within each embodiment should typically be considered as available for other similar features or aspects in other embodiments.

While this disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims, and equivalents thereof. Therefore the aforementioned example embodiments should be understood to be merely examples but not limiting this disclosure in any way.

What is claimed is:

1. An electrolyte comprising:
a non-aqueous organic solvent;
a lithium salt; and
an additive represented by Chemical Formula 1, 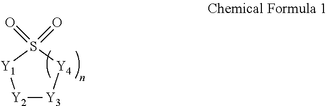
wherein, in Chemical Formula 1, one selected from among Y₁ to Y₄ is a structure of Chemical Formula 2, and each remaining selected from among Y₁ to Y₄ is a structure of Chemical Formula 3,
wherein n is an integer of 1 to 5, 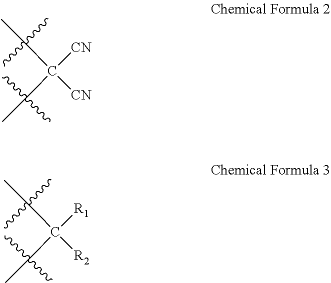
wherein, in Chemical Formula 3, R₁ and R₂ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
wherein the electrolyte being for a rechargeable lithium battery.

2. The electrolyte as claimed in claim 1, wherein Chemical Formula 1 comprises two cyano groups (—CN) connected to a carbon atom.

3. The electrolyte as claimed in claim 1, wherein Chemical Formula 2 is positioned on a carbon atom not adjacent to a sulfonyl group (—SO₂).

4. The electrolyte as claimed in claim 1, wherein the additive is represented by one selected from among Chemical Formulae 1-1, 1-2, and 1-3,

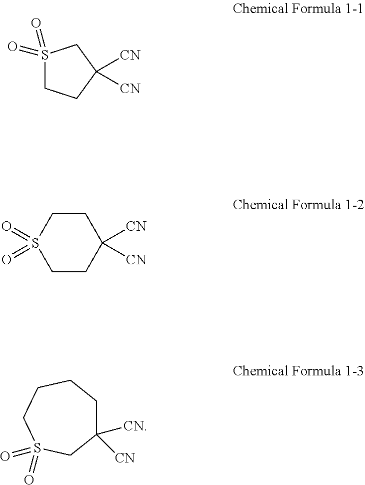 [SMILES: N#CC1(C#N)CCS(=O)(=O)C1 ; N#CC1(C#N)CCS(=O)(=O)CC1 ; N#CC1(C#N)CCCCS(=O)(=O)C1]

5. The electrolyte as claimed in claim 1, wherein an amount of the additive is about 0.01 wt % to about 10 wt % relative to a total weight of the electrolyte.

6. The electrolyte as claimed in claim 1, wherein the non-aqueous organic solvent comprises at least one selected from among ethylmethyl carbonate (EMC), ethylene carbonate (EC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

7. The electrolyte as claimed in claim 1, wherein the non-aqueous organic solvent comprises ethylmethyl carbonate (EMC), ethylene carbonate (EC), and dimethyl carbonate (DMC),
wherein a volume ratio of the ethylmethyl carbonate (EMC), the ethylene carbonate (EC), and the dimethyl carbonate (DMC) is about 1:a:b,
wherein a is about 1 to about 3, and
wherein b is about 5 to about 8.

8. The electrolyte as claimed in claim 1, wherein the lithium salt comprises at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), and LiC₄F₉SO₃.

9. The electrolyte as claimed in claim 1, wherein a concentration of the lithium salt is about 0.1 M to about 2.0 M.

10. A rechargeable lithium battery, comprising:
a positive electrode that comprises a positive electrode active material;
a negative electrode that comprises a negative electrode active material; and
the electrolyte as claimed in claim 1.

11. The rechargeable lithium battery as claimed in claim 10, wherein the positive electrode active material comprises cobalt-free nickel-manganese-based oxide, lithium-nickel-based oxide, lithium-cobalt-based oxide, lithium-manganese-based oxide, lithium-iron-phosphate-based compounds, or any combination thereof.

12. The rechargeable lithium battery as claimed in claim 10, wherein the negative electrode active material comprises a carbon-based negative electrode active material, a silicon-based negative electrode active material, or a combination thereof.

13. The rechargeable lithium battery as claimed in claim 12, wherein the silicon-based negative electrode active material comprises a silicon-carbon composite.

14. The rechargeable lithium battery as claimed in claim 10, wherein the rechargeable lithium battery is configured to be operable at a voltage of at least about 4.5 volt (V).
